(19) United States
(12) Patent Application Publication
(10) Pub. No.: US 2022/0259069 A1
(43) Pub. Date: Aug. 18, 2022

(54) DEVICE FOR PRODUCTION OF REDOX WATER

(71) Applicants: Jan Karch, Piekary Slaskie (PL); Miroslaw Gluch, Katowice (PL)

(72) Inventors: Jan Karch, Piekary Slaskie (PL); Miroslaw Gluch, Katowice (PL)

(21) Appl. No.: 17/359,460

(22) Filed: Jun. 25, 2021

(30) Foreign Application Priority Data
Feb. 13, 2021 (PL) P.436951

(51) Int. Cl. C02F 1/00; F15D 1/06; C02F 1/34

(52) U.S. Cl. CPC C02F 1/005; F15D 1/065; C02F 2209/30; C02F 1/34; C02F 2201/005; C02F 1/006

(57) ABSTRACT

The subject of the invention is a device for the production of Redox water characterized by an increased amount of molecular hydrogen in its composition. A device for the production of Redox water of potential below −100 mV uses a spirally wound corrugated pipe, a water source, a water pump, a blow-off valve, a vent, and a gauge. The components are connected into one closed system. Water circulating in the closed system of the spirally wound corrugated pipe is kept under specific pressure. For the pipe, a ratio of diameters is in a fixed diameter range, and a ratio of distances between particular coils parallel to one another is within a distance range.

### PRIORITY CLAIM

The instant application claims priority to Polish Patent Application P.436951 filed on Feb. 13, 2021, presently pending, the contents of which are hereby incorporated by reference.

### BACKGROUND OF THE INVENTION

The subject of the invention is a device for the production of Redox water which is characterized by an increased amount of H₂ molecular hydrogen in its composition.

The first research on the effects of hydrogen contained in water on the human body was conducted in the 1980s in Japan. It showed that hydrogen-saturated waters help to remove free radicals, improve immunity on a cellular level and have beneficial effects on body metabolism, which directly translates into maintaining good health. These facts are confirmed by the fact that the famous Lourdes waters, associated with their positive impact on health, contain high levels of hydrogen.

Low REDOX potential indicates extensive antioxidant capabilities of food products, in this case of water, widely recognized as very healthy and beneficial for the body; however, hydrogen concentration needs to be taken into consideration, in particular H₂ molecular hydrogen concentration, since therapeutic properties are demonstrated by water saturated with molecular hydrogen of 1.2 mg/I concentration.

Currently, to produce REDOX water, in other words, beneficial water, as low as possible potential measured in mV, ionization methods allowing to generate electrons by electrodes are used, which are undesirable due to ionization and which require regular servicing. Also in use are chemical methods consisting of passing water through special deposits, which are also cumbersome since they require systematic cleaning of deposits, replacement of used filters and cleaning of the whole water distribution system.

The aim of the invention is to develop a device for the production of Redox water of potential much below −100 mV, which is obtained with the use of physical methods by a system of a spiral made from special corrugated pipes, in which water structure is changed by tearing large molecules of water apart and releasing hydrogen which supplies electrons causing beneficial REDOX.

### SUMMARY OF THE INVENTION

A device for the production of Redox water of potential below −100 mV, according to the invention, is characterized by that it consists of components connected into one closed system in the form of a spirally wound corrugated pipe connected to a water source and a water pump, a blow-off valve, a vent, and a gauge, whereby water circulating in the closed circuit of the spirally wound corrugated pipe is kept under pressure not lower than 2 bars and not higher than 6 bars and in which the ratio of diameters according to “D” to “d” or “D” to “d” is contained in the range from 1.05 to 1.35, whereas the ratio of distances “T” or “T” between particular coils parallel to one another or diagonal to one another, to the diameters “d” or “d” is contained in the range from 0.06 to 0.14. The ratio of diameters according to “D” to “d” or “D” to “d” is preferably 1.3. The ratio of distances T or T′ between particular coils parallel to one another or diagonal to one another, to the diameters “d” or “d” is preferably 0.1. The blow-off valve allows drawing water which is automatically replenished in the system through a feeder.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 presents a schematic diagram of the device for the production of Redox water, according to one embodiment of the invention.

FIG. 2 presents the cross-section of the corrugated pipe of diagonal coils, of one embodiment of the invention; and

FIG. 3 presents the cross-section of the corrugated pipe of coils parallel to one another, in one embodiment of the invention.

### DETAILED DESCRIPTION OF THE INVENTION

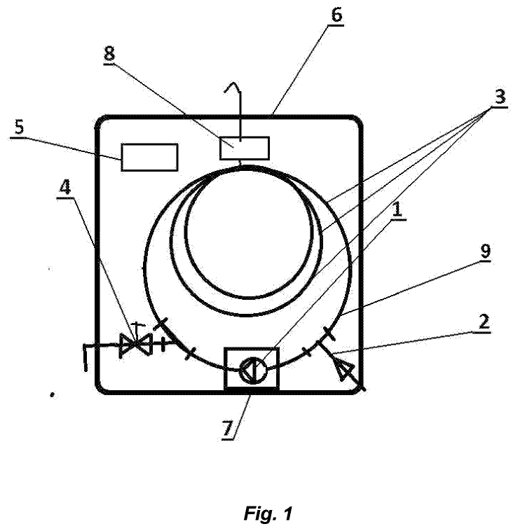

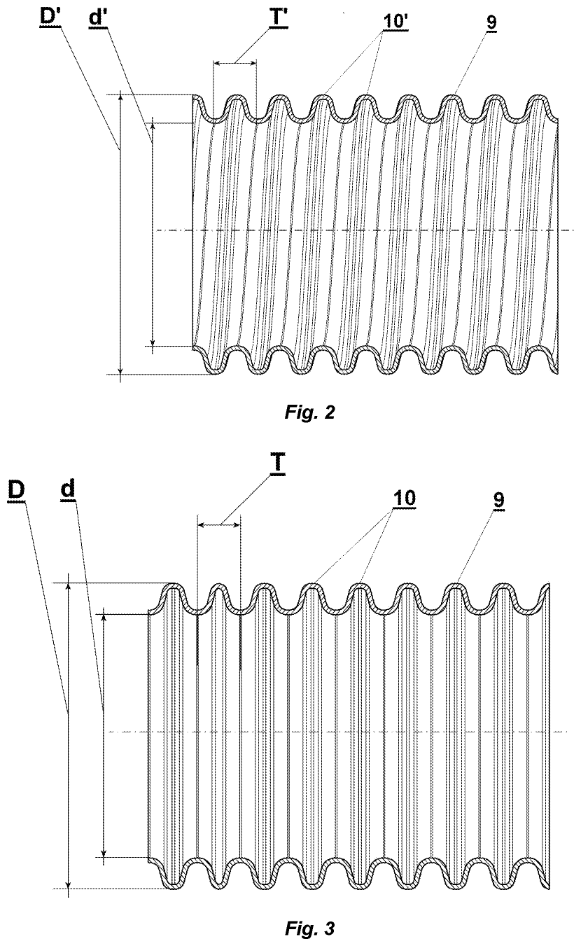

The subject of the invention is presented in the embodiment in a drawing, where FIG. 1 presents a schematic diagram of the device for production of Redox water, FIG. 2 presents the cross-section of the corrugated pipe of diagonal coils, and FIG. 3 presents the cross-section of the corrugated pipe of coils parallel to one another.

The device for the production of Redox water placed in a housing 6 is connected to a water source 2 of a minimal overpressure so that the components of the internal circuit of water are filled and to a power source 7, which powers a pump 1 and a Redox gauge 5.

After connecting the device to water and starting the motor of the pump 1, with the closed valve 4 water fills the hydraulic system circulating in a spiral 3 created by corrugated pipes 9 and air leaves the system through an automatic vent 8 until the system is fully filled and there is a signal on the gauge that the system is ready to draw water through the valve 4.

The device is equipped with a REDOX measurement whose value is presented on the gauge 5. Water circulates under high pressure of minimum 2 bars and maximum 6 bars through the spiral 3 made from the corrugated pipe 9, in which the ratio of diameters “D” to “d” or “D” to “d” is contained in the range from 1.05 to 1.35, preferably 1.3. In contrast, the ratio of distances “T” or “T” between particular coils 10 or 10′ parallel to one another or diagonal to one another, to diameters “d” or “d” is contained in the range from 0.06 to 0.14, preferably 0.1. Thus, the structure of water is changed by tearing large molecules of water apart and releasing hydrogen, which supplies electrons, causing the beneficial REDOX potential.

During regular operation of the device when it is vented, each opening of a tap 4 causes water inflow and its replenishment in the system. When the device is switched on, and the pump is working, the REDOX potential is continuously improving.

The device does not require extraordinary maintenance, and due to its simple design, cleaning and sanitization are facilitated, which can be performed by the device user. Water supplied by the device does not lose its purity and is as clean as water fed to the device.

In summary, the subject of the invention is a device for the production of Redox water which is characterized by an increased amount of H₂ molecular hydrogen in its composition.

A device for the production of Redox water of potential below −100 mV consists of components connected with one another into one closed system in the form of a spirally wound corrugated pipe 9 connected to a water source 2 and a water pump 1, a blow-off valve 4, a vent 8 and a gauge 5. Water circulating in the closed circuit of the spirally wound corrugated pipe 9 is kept under pressure not lower than 2 bars and not higher than 6 bars and in which the ratio of diameters according to “D” to “d” or “D” to “d” is preferably 1.3. The ratio of distances “T” or “T” between particular coils 10 or 10′ parallel to one another or diagonal to one another, to the diameters “d” or “d” is preferably 0.1.

1. A device for production of Redox water of potential below −100 mV comprising:
a spirally wound corrugated pipe;
a water source;
a water pump;
a blow-off valve;
a vent;
a gauge;
wherein said pipe, water source, water pump, valve, vent, and gauge are connected with one another into one closed system;
wherein water circulating in the closed system of the spirally wound corrugated pipe is kept under pressure not lower than 2 bars and not higher than 6 bars;
wherein the pipe comprises features having a ratio of diameters is in a fixed diameter range and a ratio of distances between particular coils parallel to one another is within a specific distance range.

2. The device according to claim 1, wherein the ratio of diameters “D” to “d” or “D” to “d” is contained in the range from 1.05 to 1.35 and wherein the ratio of distances “T” or “T” between particular coils parallel to one another or diagonal to one another, to the diameters “d” or “d” is contained in the range from 0.06 to 0.14.

3. The device according to claim 2 wherein the ratio of diameters according to “D” to “d” or “D” to “d” is preferably 1.3.

4. The device according to claim 2 wherein the ratio of distances T or T′ between particular coils or parallel to one another or diagonal to one another, to the diameters “d” or “d” is preferably 0.1.

5. The device according to claim 1 wherein the blow-off valve allows drawing water which is automatically replenished in the system through a feeder.
